(19) United States
(12) Patent Application Publication
(10) Pub. No.: US 2002/0176421 A1
(43) Pub. Date: Nov. 28, 2002

(54) automatic degenerate code generating circuit

(75) Inventor: Toshimitsu Munemori, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/968,981

(22) Filed: Oct. 3, 2001

(30) Foreign Application Priority Data
May 23, 2001 (JP) 2001-154366

(51) Int. Cl. H04L 12/28; H04L 12/56

(52) U.S. Cl. 370/395.1

(57) ABSTRACT

An automatic degenerate code generating circuit includes an internal code holding section and an internal code generating section. The internal code holding section stores an internal code with a degenerate number of bits at the address corresponding to an input code including an identifier or identifiers in an ATM cell. The internal code generating section generates an internal code corresponding to a new input code every time the new input code is supplied, and stores the internal code into the internal code holding section. Problems are solved of a conventional automatic degenerate code generating circuit in that it must register the internal codes in advance, which is time consuming, and in addition it takes a long time to retrieve the internal code from the internal code holding section.

### BACKGROUND OF THE INVENTION

1. Field of the Invention

The present invention relates to an automatic degenerate code generating circuit in an ATM transfer apparatus for generating a new connection number for an ATM (Asynchronous Transfer Mode) cell header by degenerating an address given by VPI (Virtual Path Identifier)/VCI (Virtual Channel Identifier) values in the input ATM cell header.

2. Description of Related Art

It is specified that an ATM transfer apparatus transfers information using a fixed length (53-byte) ATM cell. In an ATM network, a VC (Virtual Channel) is established between user terminals for communication. In addition, when transferring an ATM cell, a 16-bit VCI (Virtual Channel Identifier) included in an ATM cell header is provided with a logical number. The ATM transfer apparatus connected with the user terminal carries out the cell processing and routing in response to the VCI value.

In the ATM transfer apparatus, a VP (Virtual Path), a “bundle” of the virtual channels for respective routes, is also established. As for the VP, a logical number is assigned to the 8-bit or 12-bit VPI (Virtual Path Identifier) included in the ATM cell header. Each ATM transfer apparatus performs information transfer on a VP connection routed in response to the VPI value. Thus, each ATM transfer apparatus transmits its information by the ATM cells through the VC and VP transfer. The ATM transfer apparatus uses the VPI/VCI values as a connection identifier.

For example, a specification that assigns eight bits to the VPI value and 16 bits to the VCI value can achieve the total of 2²⁴ connections. However, the total number of actually required connections is usually much smaller than the specified total number. In such a case, information management of individual connections using all the possible VPI/VCI values makes it necessary to reserve an area for storing the management information of all the VPI/VCI values, thereby increasing unused area. This presents a problem of impairing efficient use of the resources, and taking longer time to search the memory area.

To solve the foregoing problems, a degenerate converting method and apparatus of an ATM cell header is disclosed in Japanese patent application laid-open No. 11-68788. FIG. 9 is a block diagram showing the conventional degenerate code converter. In this figure, the reference numeral 50 designates a parameter calculation section; 51 designates a retrieval section; and 52 designates an internal code holding section.

Next, the operation of the conventional apparatus will be described.

In this apparatus, the input code has one-to-one correspondence with an internal code to be output. The internal codes are stored in the internal code holding section 52 so that the internal code corresponding to each input code is retrieved in response to an internal code retrieval parameter when the input code is supplied.

Receiving the input code, the parameter calculation section 50 calculates the internal code retrieval parameter from the input code. According to the retrieval parameter, the retrieval section 51 retrieves the internal code stored in the internal code holding section 52, and outputs it. Thus, recording the internal codes in the internal code holding section 52 in advance makes it possible to obtain the internal code corresponding to the input code.

The conventional degradation converter with the foregoing configuration must register the internal codes in advance, thereby requiring much time and manpower. In addition, it has a problem of taking much time when the retrieval section 51 retrieves the internal code from the internal code holding section 52.

### SUMMARY OF THE INVENTION

The present invention is implemented to solve the foregoing problems. It is therefore an object of the present invention to provide an automatic degenerate code generating circuit that can obviate the need for registering the internal codes in advance, and output the internal code corresponding to the input code simply and quickly.

According to a first aspect of the present invention, there is provided an automatic degenerate code generating circuit which is installed in an ATM communication apparatus constituting an ATM communication network, and which generates a degenerated internal code by receiving an input code including at least one of a virtual path identifier and a virtual connection identifier assigned to an ATM cell, the automatic degenerate code generating circuit comprising: an internal code holding section for readably storing an internal code with a degenerated bit number at an address corresponding to at least one of the virtual path identifier and the virtual connection identifier of the ATM cell; and an internal code generating section for generating an internal code corresponding to the input code every time a new input code is supplied, and for feeding the generated internal code back to the internal code holding section.

Here, the internal code holding section may comprise a latch section, and a compressed code memory having a number of addresses corresponding to a number of bits of the input code, wherein the compressed code memory may include: a compressed code storing section for storing an internal code with a degenerate number of bits at each address of the compressed code memory; and a registration indicating section including a registration indicating bit for indicating presence or absence of the internal code at each address, and the latch section may latch and output the internal code stored at the address of the compressed code memory corresponding to the input code, when the registration indicating bit at the address has already been set when the input code is supplied, and wherein when the registration indicating bit at the address has not yet been set when the input code is supplied, the internal code generating section may generate a new internal code and store it in the compressed code storing section at the address corresponding to the input code.

The internal code generating section may comprise a counter for generating and holding an internal code with a new value every time a new input code is supplied.

The counter may increments its counter value by one every time a new input code is supplied, and hold the counter value as the internal code with a new value.

The internal code holding section may comprise a latch section and a compressed code memory that receives an input code including both the virtual path identifier and virtual connection identifier, and that consists of N first areas, each of which has a number of addresses corresponding to a number of bits of a first one of the two identifiers, where N is an integer corresponding to a number of bits of a second one of the two identifiers, wherein the compressed code memory may include: a compressed code storing section for storing an internal code with a degenerate number of bits at an address of the first area corresponding to one of values of the first one of the two identifiers; a registration indicating section for holding a registration indicating bit indicating presence or absence of the internal code at each address; and a selection signal storing section for holding values of the second one of the two identifiers, and the latch section may output the internal code stored at the address of the compressed code memory corresponding to the input code, when the registration indicating bit at the address has already been set when the input code is supplied, and wherein when the registration indicating bit at the address has not yet been set when the internal code is input, the internal code generating section may generate a new internal code according to the value stored in the selection signal storing section, and store the new internal code in the compressed code storing section at the address of the first area corresponding to the input code.

The internal code generating section may comprises: a decoder for decoding the value held in the selection signal storing section every time the internal code is input, and for outputting the decoded result as a selection signal; N counters each of which generates and holds, when selected by the selection signal, a new internal code for one of the N first areas every time a new input code is supplied; and N AND circuits for selecting one of the N counters in response to the selection signal, when the registration indicating bit of the compressed code memory has not yet been set at the address corresponding to the input code.

### BRIEF DESCRIPTION OF THE DRAWINGS

FIG. 1 is a schematic diagram showing a configuration of an embodiment 1 of the automatic degenerate code generating circuit in accordance with the present invention;

FIG. 2 is a block diagram showing an internal configuration of the embodiment 1 of the automatic degenerate code generating circuit;

FIG. 3 is a schematic diagram showing an internal memory map of a compressed code memory 10 of the embodiment 1;

FIG. 4 is a schematic diagram illustrating an internal code generating operation in the embodiment 1;

FIG. 5 is a block diagram showing an internal configuration of an embodiment 2 of the automatic degenerate code generating circuit in accordance with the present invention;

FIG. 6A is a truth table of a decoder in the embodiment 2 of the automatic degenerate code generating circuit;

FIG. 6B is a block diagram showing a major portion of a compressed code generating counter 23 of the embodiment 2;

FIG. 7 is a schematic diagram showing an internal memory map of a compressed code memory 20 of the embodiment 2;

FIG. 8 is a schematic diagram illustrating an internal code generating operation in the embodiment 2; and

FIG. 9 is a block diagram showing a conventional degenerate code converter.

### DETAILED DESCRIPTION OF THE PREFERRED EMBODIMENTS

The invention will now be described with reference to the accompanying drawings.

Embodiment 1

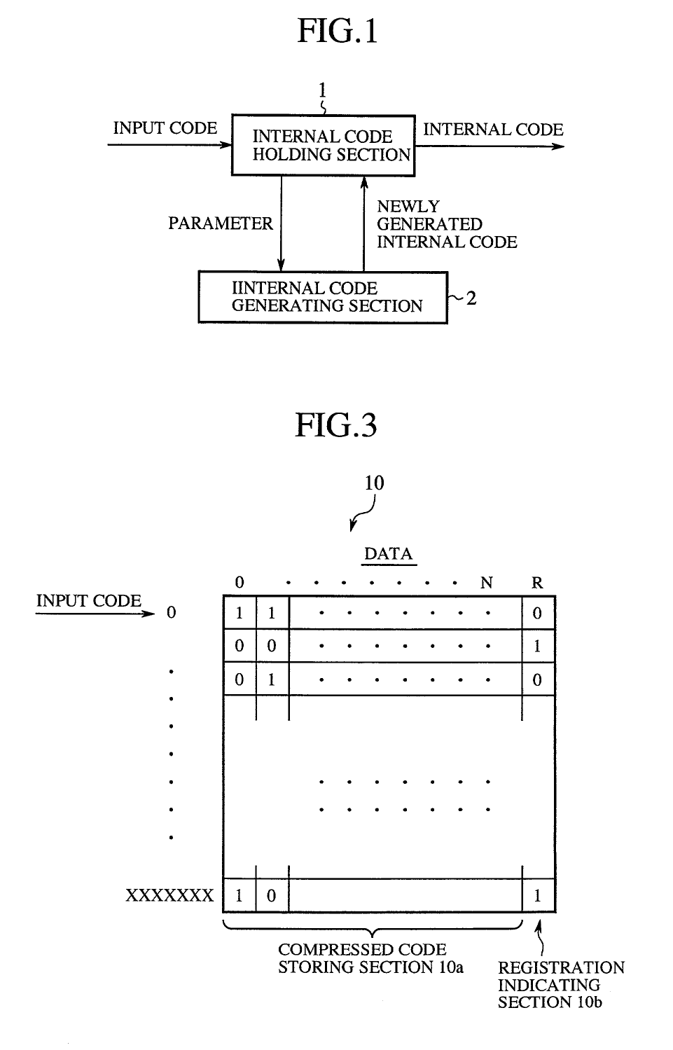

FIG. 1 is a block diagram showing a configuration of an embodiment 1 of the automatic degenerate code generating circuit in accordance with the present invention. In FIG. 1, the reference numeral 1 designates an internal code holding section for converting an input code to an internal code; and 2 designates an internal code generating section for supplying the internal code holding section 1 with the internal code generated in response to the input code.

The input code corresponds to destination data in an ATM cell that includes the input code, control data and transmitted data.

The internal code holding section 1 receives the VPI (eight bits) of the ATM cell as its input code, carries out address degenerate processing thereof, and outputs the corresponding internal code of six bits, for example. The internal code holding section 1 includes a converter for outputting the internal code at the address corresponding to the input code, and makes a decision as to whether the input code is a new input or not referring to the converter.

When the input code is new, the internal code holding section 1 supplies the input code to the internal code generating section 2 as a parameter. According to the input sequence of the input code, the internal code generating section 2 generates the internal code, and stores the new internal code into the converter of the internal code holding section 1 that outputs it. The new internal code is stored with registration indicating information. The registration indicating information indicates that the internal code has already been registered in the converter of the internal code holding section 1. In other words, it is used as reference data indicating whether the input code is a new input or not.

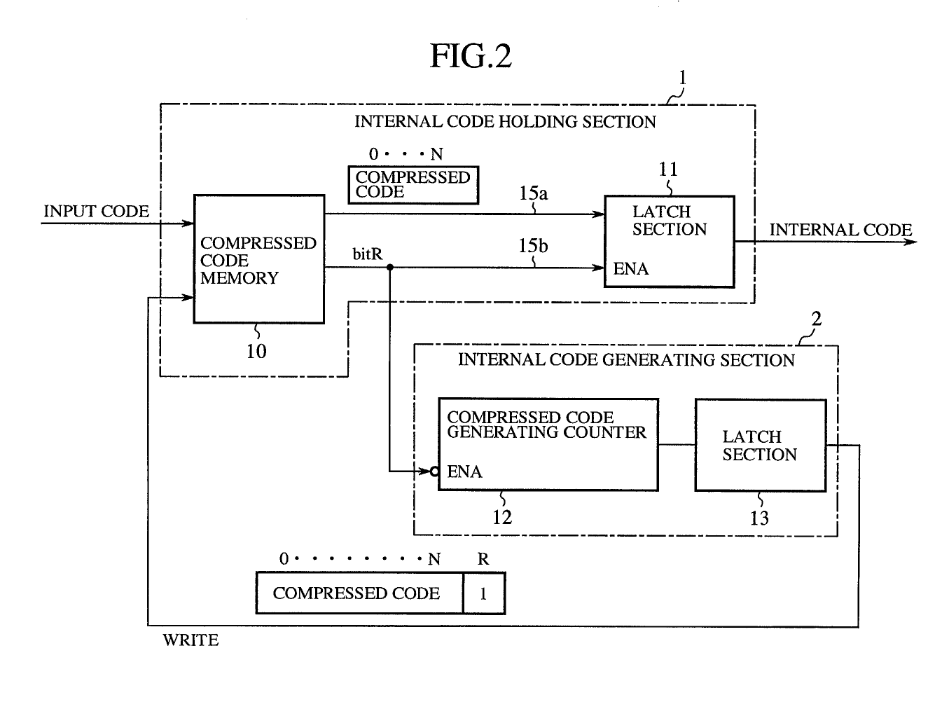

FIG. 2 is a block diagram showing an internal configuration of the circuit as shown in FIG. 1. In FIG. 2, the reference numeral 10 designates a compressed code memory that receives the input code and outputs the compressed internal code; 11 designates a latch section (flip-flops) for holding the internal code output from the compressed code memory 10; 12 designates a compressed code generating counter for generating a new internal code in response to a new input code; and 13 designates a latch section (flip-flops) for holding the newly generated internal code, and feeds it back to the compressed code memory 10. Here, the compressed code memory 10 and the latch section 11 constitute the internal code holding section 1, and the compressed code generating counter 12 and the latch section 13 constitute the internal code generating section 2 of FIG. 1.

FIG. 3 is a schematic diagram illustrating an internal memory map of the compressed code memory 10. The compressed code memory 10 has addresses, the number of which is determined by the number of bits of the input code, and each of which includes of a compressed code storing section 10a (bits 0-N), and a 1-bit registration indicating section 10b (bit R).

More specifically, when the input code consists of 8 bits, 256 addresses 0-255 are set corresponding to the 8-bit input codes. The compressed code storing section 10a stores one of N-bit (64 for N=6) compressed codes (0-5th bits) as the internal code at the address corresponding to the input code. The registration indicating section 10b stores 1-bit registration indicating bit (6th bit) as the registration indicating information corresponding to the compressed code. Each registration indicating bit of the registration indicating section 10b is changed from “0” to “1” when the compressed code is generated. Thus, the total of 64 (6-bit) compressed codes can be output as the internal codes, thereby degenerating the 256 different input codes to the 64 internal codes.

The compressed code memory 10 reads the compressed code (0-5th bits) from the address corresponding to the input code, and supplies the compressed code to the latch section 11 via a data line 15a as the internal code. At the same time, the compressed code memory 10 supplies the registration indicating bit “0/1” of the registration indicating section 10b, which indicates the presence or absence of the compressed code at the current address, to the latch section 11 and the compressed code generating counter 12 through a parameter line 15b.

The latch section 11 can hold the 6-bit compressed code supplied via the data line 15a, and outputs the compressed code as the internal code. The presence or absence of the compressed code in the latch section 11 is indicated by the registration indicating bit (bit R) on the parameter line 15b connected to its ENA (enable) terminal. When the registration indicating bit of the ENA terminal is “0” (when the compressed code has not yet been registered), the input compressed code is not held nor output. In contrast, when the registration indicating bit is “1”, the compressed code is held and output as the internal code.

The compressed code generating counter 12 outputs a 6-bit (0-5th bit) counter value corresponding to the N=6. The compressed code generating counter 12 receives at its ENA terminal the inverted value of the registration indicating bit on the parameter line 15b. The compressed code generating counter 12 increments its counter value by one every time the input code associated with the registration indicating bit of “0” is input, and supplies the latch section 13 with the counter value. In contrast, when the registration indicating bit is “1”, it does not increment its counter value.

Thus, the compressed code generating counter 12 operates only when the input code is new, so that it generates a new counter value every time a new input code is supplied.

The latch section 13 holds the 6-bit counter value output from the compressed code generating counter 12, and feeds it back to the compressed code memory 10. Thus, the compressed code generating counter 12 and the latch section 13 generate the compressed code corresponding to the new input code every time it is input, and feeds the compressed code back to the compressed code memory 10.

Thus, every time the new input code is supplied, the configuration as shown in FIG. 2 enables the compressed code memory 10 to store the newly generated compressed code fed back from the latch section 13 at the address of the compressed code storing section 10a indicated by the new input code. At the same time, the compressed code memory 10 changes the registration indicating bit at the address corresponding to the newly generated compressed code from “0” to “1” to indicate that the registration of the compressed code has been completed.

Next, the operation of the present embodiment 1 will be described.

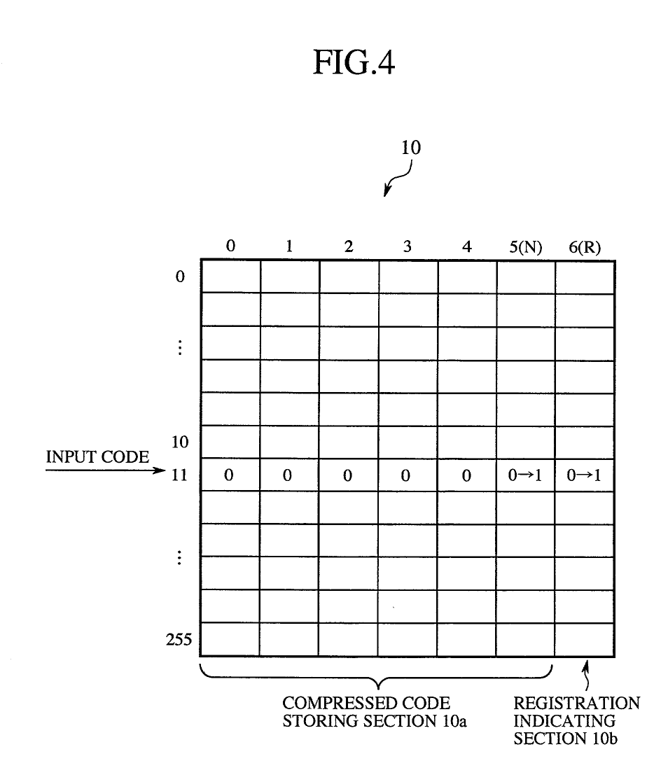

FIG. 4 is a diagram illustrating the operation when the compressed code memory 10 is supplied with a new input code, and the address the VPI indicates is “11” (decimal). In this case the access is made to the address 11 of the compressed code memory 10. When the compressed code is not yet stored at the address 11 in the compressed code storing section 10a of the compressed code memory 10 (all the 0-5th bits of the address are “0”), the corresponding registration indicating bit (6th bit) of the address 11 is “0”.

Thus, the parameter line 15b carries “0”, thereby disabling the latch section 11 and enabling the compressed code generating counter 12. As a result, the counter value is incremented from its initial value “0” to “1” (that is, “000001” in the 6-bit notation). The counter value is supplied to the latch section 13. The latch section 13 holds the counter value, and feeds it back to the compressed code memory 10.

As illustrated in FIG. 4, the compressed code memory 10 stores the 6-bit counter value (only 5th bit of which is “1”) at the address 11 in the compressed code storing section 10a. At the same time, the compressed code memory 10 changes the registration indicating bit (6th bit) at the address 11 of the registration indicating section 10b from “0” to “1”.

As a result, when the input code is 8-bit “11” (decimal), the 6-bit internal code “1” (decimal) is output from the latch section 11.

Subsequently, as for the input code of “11” (decimal), since the compressed code memory 10 has already stored the compressed code “1” (decimal) at the corresponding address 11, every time the input code “11” (decimal) is input, the parameter line 15b carries “1”, thereby disabling the compressed code generating counter 12 and the latch section 13 in the feedback loop. In contrast, the latch section 11 is enabled so that it holds the compressed code “1” (decimal) stored in the compressed code storing section 10a of the compressed code memory 10, and outputs the compressed code as the internal code.

As for a subsequent new input code, the compressed code storing section 10a does not store the compressed code corresponding to the new input code, and hence the registration indicating bits is “0”. Therefore, the compressed code generating counter 12 increments its counter value to “2” (decimal), and feeds it back to the compressed code memory 10 through the latch section 13. Thus, the compressed code (internal code) of the second new input code becomes “2” (decimal), placing only the 4th bit of the 6 bits at “1”. Thus, every time a new input code is supplied, a compressed code (internal code) is generated whose value is incremented by one sequentially.

As described above, the present embodiment 1 can carry out the retrieval processing of the internal code corresponding to the input code very quickly by means of hardware processing of memory access. In addition, it can make a decision as to whether the input code is new or not simply by only referring to the registration indicating bit in the compressed code memory.

As for the new input code, the counter value incremented by one every time the input code is input is used as the internal code, thereby enabling the degenerate processing with a simple circuit configuration.

Thus, the present embodiment 1 can achieve the generation and retrieval of the internal code by means of hardware. As a result, it offers an advantage of being able to enhance the speed of the address degenerate processing with simple circuit configuration.

Embodiment 2

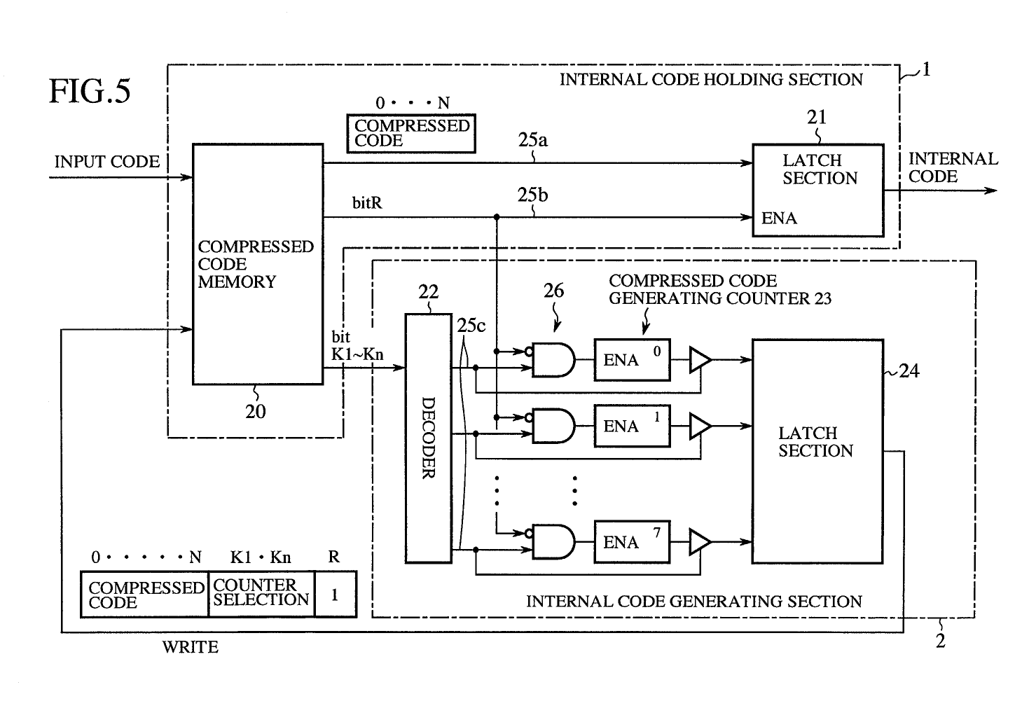

FIG. 5 is a block diagram showing a configuration of an embodiment 2, which represents an internal configuration of the blocks of FIG. 1. The present embodiment 2 is configured such that it receives a double-layer input code (VPI+VCI), and generates a plurality of internal codes based on the VCI value for each VPI.

In FIG. 5, the reference numeral 20 designates a compressed code memory that receives the input code (VPI+VCI) and outputs an internal code; 21 designates a latch section (latch FFs) for holding the internal code output from the compressed code memory 20; 22 designates a decoder for selecting a counter used for generating a new internal code for each VCI when a new input code occurs; 23 designates a plurality of compressed code generating counters selectable by the decoder 22; and 24 designates a latch section (latch FFs) for holding the internal code newly generated by each of the compressed code generating counters 23, and for feeding it back to the compressed code memory 20.

In the following example, it is assumed that the VPI and VCI of the input code have 3-bit values (0-7) and 8-bit values (0-255), respectively, and that the compressed code memory 20 includes corresponding 8×256=2048 (0-2047) addresses. It is further assumed as in the foregoing embodiment 1 that the internal codes associated with the VCIs of each VPI consists of 6-bit (64) compressed codes (internal code addresses of 0-63) with 0th-Nth (N=5) bits. The compressed code memory 20 extracts the 3 bits (bits K1-Kn) of the input VPI, and supplies them to the decoder 22.

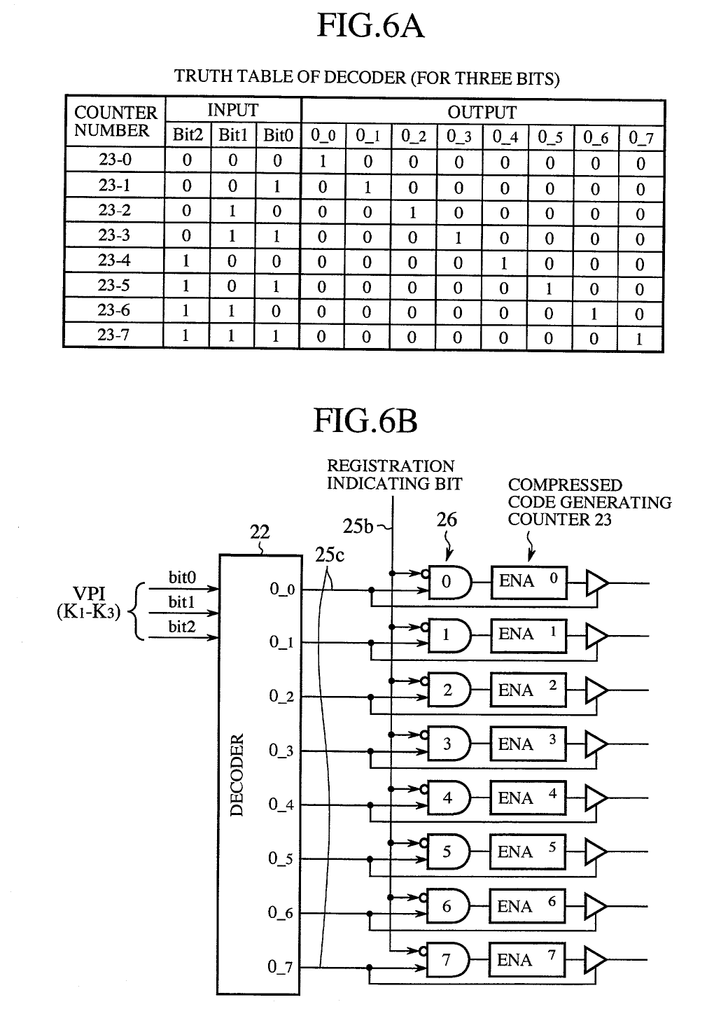

FIGS. 6A and 6B are diagrams illustrating the selection of the compressed code generating counter 23 by the decoder 22. As illustrated in the truth table of FIG. 6A, the decoder 22 supplies the compressed code generating counter 23 with one of 2ⁿ (eight for n=3) selection outputs (O-0-O-7) as a selecting signal through parameter lines 25c in response to the compressed code selecting bits (bits K1-Kn) consisting of the VPI values. The compressed code generating counters 23 includes eight counters (23-0-23-7) in accordance with the selection number.

Receiving the 3-bit VPI value (bits K1-K3) extracted by the compressed code memory 20, the decoder 22 selects one of the counters 23-0-23-7 corresponding to the VPI value. Selecting one of the counters 23-0-23-7 allows the value of the internal code, which is generated by the selected counter in accordance with the input VCI value for each VPI value, to be incremented.

As show in FIG. 6B, there is provided before the counters 23-0-23-7 an AND circuit 26 consisting of a plurality of AND gates 26-0-26-7 each outputting a logical AND between the inverted value of the registration indicating bit (bit R) and one of the selection outputs (O-0-O-7) of the decoder 22. Thus, only when the registration indicating bit (bit R) is zero which is associated with the counter 23-i selected by the AND circuit 26 in response to the VPI value fed through the decoder 22, the compressed code generating counter 23-i increments its counter value (internal code) according to the input VCI value.

For example, when the VPI value is “3” (decimal) and hence its bits are “011”, the decoder 22 supplies the AND gate 26-3 with the selection signal from the output port O-3, thereby selecting the counter 23-3. In response to the selection, the counter 23-3 increments its counter value when the corresponding registration indicating bit R is “0”. At the post-stage of the counters 23-0-23-7, there are provided buffers for enabling the output of the counters in response to the selection of the parameter lines 25c.

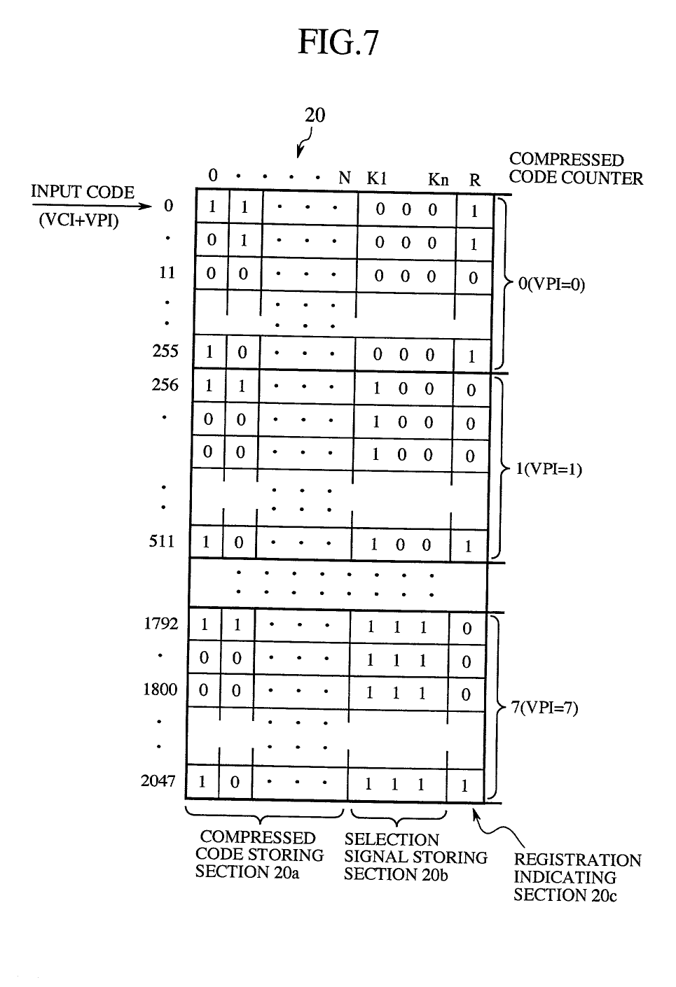

FIG. 7 is a schematic diagram showing an internal memory map of the compressed code memory 20. The compressed code memory 20 includes 256 addresses based on the 8-bit VCI for each VPI, and hence the total of 256×8=2048 (0-2047) addresses for the eight areas given by the 3-bit VPI.

Each of the addresses 0-2047 of compressed code memory 20 includes a compressed code storing section 20a for storing one of the N-bit (64 for N=6 bits) compressed codes (0-5th bits). It also includes a selection signal storing section 20b for storing the 3-bit compressed code selecting bits (bits K1-K3) for each compressed code. It further includes a registration indicating section 20c for storing the 1-bit registration indicating bit (bit R) associated with each compressed code as the registration indicating information. The registration indicating bit of the registration indicating section 20c is changed from “0” to “1” when the compressed code is generated.

Thus, the total of 64 (6-bit) compressed codes can be output as the internal codes, thereby degenerating the 256 different input codes to the 64 internal codes for each VPI.

The compressed code memory 20 reads the compressed code (0-5th bits) from the address corresponding to the input code, and supplies the compressed code to the latch section 21 via a data line 25a as the internal code. At the same time, the compressed code memory 20 supplies the registration indicating bit of the registration indicating section 20c, which indicates the presence or absence of the compressed code at the current address, to the latch section 21 and the compressed code generating counters 23 through a parameter line 25b.

The latch section 21 can hold the 6-bit compressed code supplied via the data line 25a, and outputs the compressed code as the internal code. The presence or absence of the compressed code in the latch section 21 is indicated by the registration indicating bit (bit R) on the parameter line 25b connected to its ENA (enable) terminal. When the registration indicating bit of the ENA terminal is “0” (when the compressed code is not registered), the input compressed code is not held nor output. In contrast, when the registration indicating bit is “1”, the compressed code is held and output as the internal code.

When the compressed code has been stored at the address corresponding to the input code, the decoder 22 decodes the 3-bit selection signal (bits K1-K3) stored in the selection signal storing section 20b, and supplies its decoded result to the AND circuit 26.

Receiving the two signals, the inverted registration indicating bit (bit R) fed via the parameter line 25b and the 1-bit selection signal fed from the decoder 22 via the parameter line 25b, the AND circuit 26 supplies the resultant AND between the two signals to one of the compressed code generating counters 23 (counters 23-0-23-7).

The compressed code generating counters 23 consists of the eight counters 23-0-23-7 that output an N-bit (6-bit) counter value each. Each counter 23-i increments its counter value by one only when the corresponding AND gate 26-i outputs the logical AND “1”, and supplies the counter value to the latch section 24.

In other words, every time a new input code is supplied, one of the counters 23-0-23-7 corresponding to the VPI is selected in response to the new input code, so that the selected one of the counters 23-0-23-7 generates its new counter value as the compressed code. In contrast, when the registration indicating bit is “1”, none of the compressed code generating counters 23 increment their counter values.

The latch section 24 holds the 6-bit counter value output from the compressed code generating counter 23, and feeds it back to the compressed code memory 20. Thus, every time a new input code is supplied, the corresponding one of the compressed code generating counters 23 and the latch section 24 generate the compressed code for the VPI value included in the input code, and feeds the compressed code back to the compressed code memory 20.

In other words, every time the new input code is supplied, the configuration as shown in FIG. 5 enables the compressed code memory 20 to store the newly generate compressed code fed back from the latch section 24 in the address of the compressed code storing section 20a indicated by the new input code. At the same time, the VPI value of the input code is stored into the selection signal storing section 20b. In addition, the compressed code memory 20 changes the registration indicating bit at the address corresponding to the newly generated compressed code from “0” to “1” to indicate that the registration of the compressed code has been completed.

Next, the operation of the present embodiment 2 will be described.

Assume that the new input code whose VPI value is “1” (decimal) and the VCI value is “42” (decimal) is supplied to the compressed code memory 20. In this case, the access is made to the address 298 of the compressed code memory 20. This is because the compressed code memory 20 has 256 addresses in the range from 256-511 for the VPI value “1”, and the VCI value “42” in this range gives 256+42=298.

When the compressed code is not yet stored in the address in the compressed code storing section 20a of the compressed code memory 20 (all the 0-5th bits of the address are “0”), the registration indicating bit (9th bit) of the address 298 in the registration indicating section 20c of the compressed code memory 20 is “0”. Besides, as for the bits K1-K3 (6-9th bits) of the selection signal storing section 20b, only the 6-th bit is “1” in accordance with the VPI value.

Thus, the parameter line 25b carries “0”, disabling the latch section 21 and preventing the compressed code from being output. On the other hand, the decoder 22 supplies the AND gate 26-1 with the selection signal (O-1) for selecting the counter 23-1 corresponding to the VPI value of “1” of the input code via the parameter lines 25c.

In response to the selection signal and the registration indicating bit (9th bit) of zero, the AND gate 26-1 selects the counter 23-1 of the compressed code generating counters 23.

Thus, in the compressed code generating counters 23, the counter 23-1 selected in response to the VPI value “1” increments its counter value as the internal code it generates. As a result, the counter value is incremented from its initial value “0” to “1” (that is, “000001” in the 6-bit notation). The counter value is supplied to the latch section 24. The latch section 24 holds the counter value, and feeds it back to the compressed code memory 20.

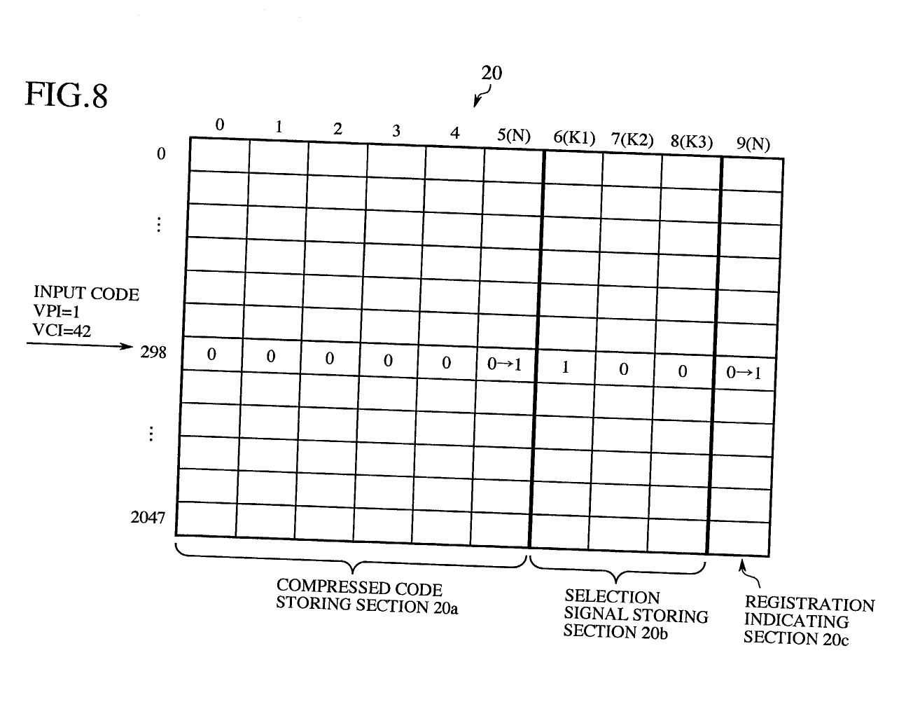

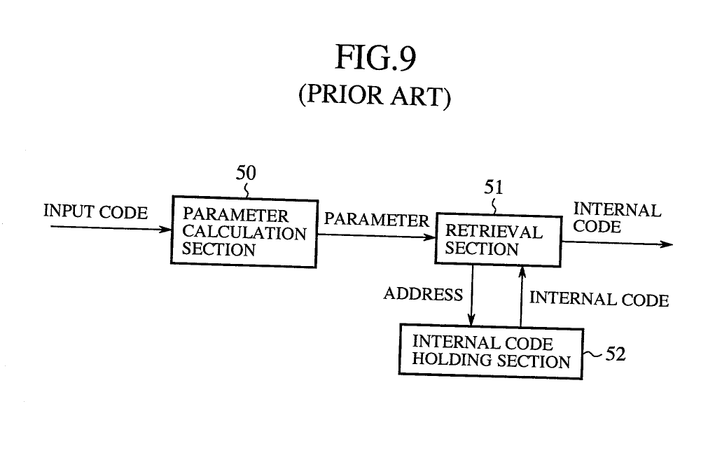

As illustrated in FIG. 8, the compressed code memory 20 stores the 6-bit counter value (only 5th bit of which is “1”) at the address 298 in the compressed code storing section 20a. At the same time, the compressed code memory 20 changes the registration indicating bit (9th bit) of the registration indicating section 20c at the address from “0” to “1”.

As a result, when the first 8-bit input code of “42” (decimal) is input, the 6-bit internal code “1” (decimal) is output from the latch section 21 to become the internal code of the VCI value and the input VPI value. Therefore, several different internal codes can be generated for the same VCI depending on the VPI values of the input code.

Subsequently, as for the input code with the VPI=1 and VCI=42 (decimal), the compressed code memory 20 has already stored the compressed code “1” (decimal) at the corresponding address. Accordingly, every time when the same input code is input, the parameter line 25b carries “1”, disabling the corresponding one of the compressed code generating counters 23 and the latch section 24 in the feedback loop. In contrast, the latch section 21 is enabled so that it holds the compressed code “1” (decimal) stored in the compressed code storing section 20a of the compressed code memory 20, and outputs it as the internal code.

As for a subsequent new input code with the same VPI value but with a different VCI, the compressed code storing section 20a has not yet stored the compressed code corresponding to the new input code, and hence the registration indicating bit is “0”. Therefore, the corresponding one of the compressed code generating counters 23 increments its counter value to “2” (decimal), and feeds it back to the compressed code memory 20 through the latch section 24. Thus, the compressed code (internal code) of the second new input code becomes “2” (decimal), placing only the 4th bit of the 6 bits at “1”. Thus, as for a new input code with the same VPI value, every time the new input code is supplied, a compressed code (internal code) is generated and held whose value is incremented by one sequentially.

As described above, the present embodiment 2 can generate different internal codes for respective VPIs by inputting a double-layer input code, and carry out the retrieval processing of the internal code corresponding to the input code very quickly by means of hardware processing of memory access. In addition, it can make a decision as to whether the input code is new or not simply by only referring to the registration indicating bit of the compressed code memory. Thus, the present embodiment 2 can make a decision whether to generated the new internal code or not very quickly.

As for the new input code, the counter value that is incremented every time a new input code takes place is used as the internal code, thereby enabling the degenerate processing with a simple circuit configuration.

Thus, the present embodiment 2 can achieve the generation and retrieval of the internal code corresponding to the double-layer input code by means of hardware. As a result, it offers an advantage of being able to enhance the speed of the address degenerate processing with a simple circuit configuration.

What is claimed is:

1. An automatic degenerate code generating circuit which is installed in an ATM communication apparatus constituting an ATM communication network, and which generates a degenerated internal code by receiving an input code including at least one of a virtual path identifier and a virtual connection identifier assigned to an ATM cell, said automatic degenerate code generating circuit comprising:
an internal code holding section for readably storing an internal code with a degenerated bit number at an address corresponding to at least one of the virtual path identifier and the virtual connection identifier of the ATM cell; and
an internal code generating section for generating an internal code corresponding to the input code every time a new input code is supplied, and for feeding the generated internal code back to said internal code holding section.

2. The automatic degenerate code generating circuit according to claim 1, wherein said internal code holding section comprises a latch section, and a compressed code memory having a number of addresses corresponding to a number of bits of the input code,
said compressed code memory including:
a compressed code storing section for storing an internal code with a degenerate number of bits at each address of said compressed code memory; and
a registration indicating section including a registration indicating bit for indicating presence or absence of the internal code at each address, and
said latch section latching and outputting the internal code stored at the address of said compressed code memory corresponding to the input code, when the registration indicating bit at the address has already been set when the input code is supplied, and
wherein when the registration indicating bit at the address has not yet been set when the input code is supplied, said internal code generating section generates a new internal code and stores it in said compressed code storing section at the address corresponding to the input code.

3. The automatic degenerate code generating circuit according to claim 2, wherein said internal code generating section comprises a counter for generating and holding an internal code with a new value every time a new input code is supplied.

4. The automatic degenerate code generating circuit according to claim 3, wherein said counter increments its counter value by one every time a new input code is supplied, and holds the counter value as the internal code with a new value.

5. The automatic degenerate code generating circuit according to claim 1, wherein said internal code holding section comprises a latch section and a compressed code memory that receives an input code including both the virtual path identifier and virtual connection identifier, and that consists of N first areas, each of which has a number of addresses corresponding to a number of bits of a first one of the two identifiers, where N is an integer corresponding to a number of bits of a second one of the two identifiers,
said compressed code memory including:
a compressed code storing section for storing an internal code with a degenerate number of bits at an address of the first area corresponding to one of values of the first one of the two identifiers;
a registration indicating section for holding a registration indicating bit indicating presence or absence of the internal code at each address; and
a selection signal storing section for holding values of the second one of the two identifiers, and
said latch section outputting the internal code stored at the address of said compressed code memory corresponding to the input code, when the registration indicating bit at the address has already been set when the input code is supplied, and
wherein when the registration indicating bit at the address has not yet been set when the internal code is input, said internal code generating section generates a new internal code according to the value stored in said selection signal storing section, and stores the new internal code in said compressed code storing section at the address of the first area corresponding to the input code.

6. The automatic degenerate code generating circuit according to claim 5, wherein said internal code generating section comprises:
a decoder for decoding the value held in said selection signal storing section every time the internal code is input, and for outputting the decoded result as a selection signal;
N counters each of which generates and holds, when selected by the selection signal, a new internal code for one of the N first areas every time a new input code is supplied; and
N AND circuits for selecting one of said N counters in response to the selection signal, when the registration indicating bit of said compressed code memory has not yet been set at the address corresponding to the input code.
